(19) United States
(12) Patent Application Publication
(10) Pub. No.: US 2012/0211690 A1
(43) Pub. Date: Aug. 23, 2012

(54) Ball Valves and Associated Methods

(75) Inventors: Jason Anderson, Girard, PA (US); Kent Hemme, Fairview, PA (US)

(73) Assignee: INNOVATIVE PRESSURE TECHNOLOGIES, Erie, PA (US)

(21) Appl. No.: 13/402,741

(22) Filed: Feb. 22, 2012

Related U.S. Application Data
(60) Provisional application No. 61/445,341, filed on Feb. 22, 2011.

(51) Int. Cl. F16K 5/06; B21D 53/00; B21D 53/10; F16K 5/20; F16K 41/00

(52) U.S. Cl. 251/315.1; 251/359; 251/214; 29/890.122; 29/890.124

(57) ABSTRACT

Exemplary embodiments are directed to ball valves and associated methods that include a valve body, a ball disposed inside the valve body, a seat retainer, a seat, a stem and a stem bearing. The exemplary seat retainer includes an outer surface with a first outer diameter, a second outer diameter and a transition region connecting the first outer diameter and the second outer diameter in a ramped manner. The exemplary seat includes an annular groove on a seat face to provide two distinct contact points between the seat and the ball. The exemplary stem passes through a valve body opening and is in mechanical communication with the ball. The exemplary stem bearing includes a bore extending therethrough, a first inner diameter, a second inner diameter and a stem bearing transition region connecting the first inner diameter and the second inner diameter in a tapered manner.

### RELATED APPLICATIONS

This application is based on and claims the priority benefit of U.S. Provisional Application No. 61/445,341, filed Feb. 22, 2011. The entire content of the foregoing provisional patent application is incorporated herein by reference.

### TECHNICAL FIELD

The present disclosure relates to ball valves and associated methods and, more particularly, to ball valves suitable for withstanding large pressure forces and operating in a variety of conditions.

### BACKGROUND

Conventional ball valves include a valve body having two or more ports with at least one passage extending through the length of the body. A spherical ball, containing one or more ports extending through the ball, is located in the midpoint of the two valve body ports. In addition, the spherical ball may be supported by one or more trunnions and is keyed to a valve stem, which extends through the valve body wall. The gap between the valve stem and the valve body is commonly sealed by, e.g., elastomeric seals or other packing material. In normal operation, external rotational forces applied to the stem rotate the ball to, e.g., open, close or redirect the flow through the internal passages in the valve body. Further, a bearing washer may be positioned between the stem and valve body to prevent damage to the valve body.

Conventionally, resilient seats, implemented in conjunction with metallic seat retainers, both support the ball and form a tight seal in the valve body. Spring washers placed over the seat retainer tail are compressed between an end adapter and follower. As the end adapter is tightened into the body, the springs compress, forcing the follower against the adapter and resilient seat into the ball to create a seal. The energy stored in the springs during assembly is controlled and assists in forming a tight seal between the ball and resilient seat.

With further particularity and with reference to FIG. 1, in a conventional ball valve 100, an elastomeric O-ring 101 effects a seal between the outside diameter of the seat retainer 102 and the inside diameter of the end adapter 103. Due to the nature of the elastomeric O-ring 101, it is able to seal pressure from both sides and further transmits the pressure load to the ball valve seat 104. Thus, a uniformly shaped outside diameter of the seat retainer 102 can be utilized. However, because elastomer materials are limited by, e.g., fluid compatibility, temperature constraints, and the like, a new arrangement that can be used over a wide range of applications is desirable.

Conventional ball valves 100 also include springs 105 to provide pressure against the seat retainer and the seat, thereby creating a spring-loaded resilient seat 104. The spring-loaded resilient seat 104 results in a free-floating follower 106. In particular, the follower 106 is only supported by the end adapter 103 and springs 105. A high enough inlet pressure acting on the upstream seat retainer 102 seal can generate a force sufficient to displace the follower 106 from the end adapter 103, further compressing the springs 105 and applying the additional force into the resilient seat 104 face against the ball 107. The result is higher seat 104 stresses, shorter seat 104 seal life, and higher operating torque.

In conventional ball valves 100 with resilient seats 104, the seat 104 configuration consists of a cylindrically shaped ring with an angled face cut on one end. The resilient seat 104 is further pressed into the seat retainer 102. When the resilient seat 104 is brought into contact with the face of the ball 107, a single ring of contact exists. When sufficient force is applied, the ball 107 face deforms the resilient seat 104 face, leaving a single concaved impression. The single and narrow contact of the resilient seat 104 against the ball 107 face can complicate the balancing of forces in the ball valve 100 while creating forces which can damage the resilient seat 104 itself.

Further, conventional ball valves 100 incorporate a spherical ball 107, containing one or more ports passing through the ball 107. The intersection of a spherical surface and an internal port of the ball 107 creates a sharp edge. This edge is occasionally broken with a radius to, e.g., prevent scraping of the surfaces of the resilient seat 104. The ball 107 is rotated by the stem, such that the port in the ball 107 crosses the resilient seat 104 surface, exposing a minute flow passage. The small area of flow passage can generate high flow pressures and/or velocities. An edge broken with a radius, as taught by the prior art, is insufficient to prevent large pressure drops across the minute area of the exposed seat 104 surface. The presence of high flow pressures and/or velocities therefore increase the risk of damage to the seat 104.

The stem of conventional ball valves 100 is exposed to the pressurized body cavity. In particular, the stem is a blowout proof design, meaning the end of the stem is larger than the opening through which it passes. Thus, the stem cannot be ejected from the valve 100. In high pressure applications, a significant force is applied to the stem shoulder. To prevent damage to the valve body, a metallic and/or thermoplastic bearing washer is placed between the stem and valve body. However, this arrangement, in large and/or high pressure valves, can generate high frictional forces, requiring significant torque to rotate the stem. In addition, due to the stem being exposed to the pressurized body cavity of the valve 100, packing and/or elastomeric seals are employed to seal the opening through which the stem passes. As described above, this arrangement can further generate high frictional forces, requiring significant torque to rotate the stem.

### SUMMARY

In accordance with embodiments of the present disclosure, ball valves and associated methods are disclosed that involve ball valves suitable for withstanding large pressure forces and operating in a variety of conditions. An exemplary ball valve as disclosed herein includes a valve body, a ball, a seat retainer and a seat. The ball is disposed inside the valve body. The seat retainer includes an outer surface with a first outer diameter, a second outer diameter and a transition region. The transition region connects the first outer diameter and the second outer diameter in a ramped manner.

The exemplary seat retainer includes a seat retainer bore extending therethrough and the first outer diameter and the second outer diameter are dimensionally unequal. The exemplary valve body includes an ingress port and an egress port. The ball further includes a ball bore extending therethrough. The exemplary ball valve can further include first and second non-elastomeric seals. It should be understood that in other embodiments, more than two non-elastomeric seals, e.g., three, four, or the like, can be used. The first and second non-elastomeric seals can be spring-loaded and dimensionally unequal.

The exemplary ball valve further includes a ramped load ring disposed between the first and second non-elastomeric seals. It should be understood that in other embodiments, more than one load ring, e.g., two, three, four, and the like, can be used with the exemplary ball valve. The ramped load ring includes a ramped load ring surface complimentary to the transition region of the seat retainer. The exemplary ball valve can also include a ramped end adapter substantially in contact with the first and second non-elastomeric seals, the ramped load ring and the seat retainer. The ramped end adapted includes a ramped end adapter surface complimentary to the transition region of the seat retainer. The ramped load ring transfers a pressure force to the seat retainer and/or a pressure force to the ramped end adapter. Transferring the pressure force to the seat retainer presses the seat against the ball to create a seat seal.

The exemplary ball can include a chamfered edge at an intersection of a spherical surface of the ball and the ball bore. The chamfered edge can be further broken with a radius. The ball can also include a trunnion. It should be understood that in other embodiments, more than one trunnion, e.g., two, three, four and the like, can be used. The exemplary ball valve includes a valve stem positioned externally to a cavity of the valve body.

In accordance with embodiments of the present disclosure, another exemplary ball valve is provided that includes a valve body, a ball, a seat retainer and a seat. The ball is disposed inside the valve body. The seat is disposed inside the seat retainer and is substantially in contact with the ball. The exemplary seat can further include an annular groove on a seat face to provide two distinct contact points between the seat face and the ball.

The exemplary ball valve can include a supported follower and an end adapter. The supported follower can be supported by at least one of the valve body and the end adapter. The seat can include, e.g., a torus-shaped convex face cut. The annular groove can be machined into the torus-shaped convex face cut. The seat can be cylindrically shaped. A first and second edge of the annular groove contact the ball simultaneously to provide two seat faces. The two distinct contact points between the two seat faces and the ball further enhance a force distribution inside the valve body.

In accordance with embodiments of the present disclosure, another exemplary ball valve is provided, including a valve body, a ball, a stem and a stem bearing. The ball is disposed inside the valve body. The stem passes through a valve body opening and is in mechanical communication with the ball. The stem bearing is disposed between the stem and the valve body. The exemplary stem bearing can further include a bore extending therethrough, a first inner diameter, a second inner diameter and a transition region. The transition region can connect the first inner diameter to the second inner diameter in a tapered manner.

The first and second inner diameters of the stem bearing can be dimensionally unequal. The stem can include a tapered stem surface configured to mate with the transition region of the stem bearing. Further, the stem bearing can be one of a metallic or a thermoplastic bearing washer. The tapered transition region of the stem bearing redirects a pressure force into the valve body.

In accordance with another exemplary embodiment, a ball valve is provided that includes a valve body, a ball, a seat retainer, a seat, a stem and a stem bearing. The ball is disposed inside the valve body. The seat retainer includes an outer surface with a first outer diameter, a second outer diameter and a seat retainer transition region. The seat retainer transition region connects the first outer diameter and the second outer diameter in a ramped manner. The seat can be disposed inside the seat retainer and is substantially in contact with the ball. The seat further includes an annular groove on a seat face to provide two distinct contact points between the seat face and the ball. The stem passes through a valve body opening and is in mechanical communication with the ball. Further, the stem bearing is disposed between the stem and the valve body. The stem bearing can include a bore extending therethrough, a first inner diameter, a second inner diameter and a stem bearing transition region. The stem bearing transition region connects the first inner diameter and the second inner diameter in a tapered manner.

In accordance with further embodiments of the present disclosure, methods of fabricating the exemplary ball valves are provided. An exemplary method of fabricating a ball valve as disclosed herein includes providing a valve body and a ball disposed inside the valve body. The method further includes providing a seat retainer that includes an outer surface with a first outer diameter, a second outer diameter and a transition region. The transition region connects the first outer diameter and the second outer diameter in a ramped manner. The exemplary method can further include providing a seat disposed inside the seat retainer and substantially in contact with the ball.

In addition, the exemplary method includes providing first and second non-elastomeric seals and a ramped load ring disposed between said first and second non-elastomeric seals. It should be understood that in other embodiments, more than two non-elastomeric seals, e.g., three, four, or the like, and more than one ramped load ring, e.g., two, three, four, or the like, can be used. A ramped end adapter is further provided substantially in contact with the first and second non-elastomeric seals, the ramped load ring and the ramped seat retainer. Further, a chamfered edge at an intersection of a spherical surface of the ball and the ball bore extending therethrough can be provided. The exemplary method can include providing a valve stem positioned externally to a cavity of the valve body.

An exemplary method of fabricating a ball valve according to the present disclosure includes providing a valve body, a ball, a seat retainer and a seat. The ball can be disposed inside the valve body. The seat is disposed inside the seat retainer and is substantially in contact with the ball. The seat can further include an annular groove to provide two distinct seat faces between the seat and the ball. The exemplary method can include providing a supported follower and an end adapter. The supported follower is supported by at least one of the valve body and an end adapter.

In another embodiment of the present disclosure, a method of fabricating a ball valve is provided, including providing a valve body, a ball, a stem and a stem bearing. The ball is disposed inside the valve body. The stem passes through a valve body opening and is in mechanical communication with the ball. The stem bearing can be disposed between the stem and the valve body and includes a bore extending therethrough, a first inner diameter, a second inner diameter and a transition region. The exemplary stem bearing transition region connects the first inner diameter to the second inner diameter in a tapered manner.

An exemplary method of fabricating a ball valve according to the present disclosure includes providing a valve body, a ball, a seat retainer, a seat, a stem and a stem bearing. The ball is disposed inside the valve body. The seat retainer includes an outer surface with a first outer diameter, a second outer diameter and a seat retainer transition region. The seat retainer transition region connects the first outer diameter and the second outer diameter in a ramped manner. The seat is disposed inside the seat retainer and is substantially in contact with the ball. The exemplary seat further includes an annular groove on a seat face ball contact portion to provide two distinct seat faces or contact points between the seat and the ball. The stem can pass through a valve body opening and is in mechanical communication with the ball. The stem bearing is disposed between the stem and the valve body and includes a bore extending therethrough, a first inner diameter, a second inner diameter and a stem bearing transition region. The stem bearing transition region connects the first inner diameter and the second inner diameter in a tapered manner.

The exemplary ball valves and associated methods according to the present disclosure provide ball valves capable of implementation in a wide range of applications, e.g., having varied fluid compatibility, temperature constraints, and the like. Further, the exemplary ball valves and associated methods provide ball valves that reduce seat stresses and operating torque, decrease pressure drops across the exposed seat surfaces and increase seat life.

Other objects and features will become apparent from the following detailed description considered in conjunction with the accompanying drawings. It is to be understood, however, that the drawings are designed as an illustration only and not as a definition of the limits of the invention.

### BRIEF DESCRIPTION OF THE DRAWINGS

To assist those of skill in the art in making and using the disclosed devices and associated methods, reference is made to the accompanying figures, wherein:

FIG. 1 illustrates a ball valve assembly as taught by the prior art;

FIG. 2 is a cross-sectional view of an exemplary embodiment of a ball valve according to the present disclosure;

FIGS. 3(a) and (b) illustrate exemplary embodiments of a ball valve seat seal and seat retainer according to the present disclosure;

FIGS. 4(a)-(c) illustrate exemplary embodiments of a ball valve with a ramped seat retainer, an end adapter and a one piece load ring according to the present disclosure;

FIGS. 5(a) and (b) illustrate exemplary embodiments of a ball valve with a ramped seat retainer, an end adapter and a two piece load ring according to the present disclosure;

FIG. 6 illustrates an exemplary embodiment of a ball according to the present disclosure;

FIGS. 7(a)-(c) illustrate exemplary embodiments of a stem according to the present disclosure;

FIGS. 8(a) and (b) illustrate exemplary embodiments of a seat according to the present disclosure;

FIG. 9 illustrates an exemplary embodiment of a seat according to the present disclosure;

FIG. 10 illustrates an exemplary embodiment of a seat according to the present disclosure;

FIG. 11 illustrates an exemplary embodiment of a supported follower according to the present disclosure; and

FIG. 12 illustrates an exemplary embodiment of a tapered stem bearing according to the present disclosure.

### DESCRIPTION OF EXEMPLARY EMBODIMENTS

In accordance with embodiments of the present disclosure, ball valves and associated methods are disclosed that involve ball valves suitable for withstanding large pressure forces and operating in a variety of conditions. An exemplary ball valve as disclosed herein includes a valve body, a ball, a seat retainer and a seat. The ball is disposed inside the valve body. The seat retainer includes an outer surface with a first outer diameter, a second outer diameter and a transition region. The transition region connects the first outer diameter and the second outer diameter in a ramped manner.

The exemplary seat retainer includes a seat retainer bore extending therethrough and the first outer diameter and the second outer diameter are dimensionally unequal. The exemplary valve body includes an ingress port and an egress port. The ball further includes a ball bore extending therethrough. The exemplary ball valve can further include first and second non-elastomeric seals. It should be understood that in other embodiments, more than two non-elastomeric seals, e.g., three, four, or the like, can be used. The first and second non-elastomeric seals can be spring-loaded and dimensionally unequal.

With reference to FIG. 2, a cross-sectional view of the exemplary ball valve 200 is provided, including a seat retainer 201, a seat 202 and a ball 203. The components of the exemplary ball valve 200 will be discussed in greater detail below. The “A” axis represents the flow path through the ball valve 200 during operating conditions. In particular, the exemplary ball valve 200 can accommodate a unidirectional and/or a bidirectional flow.

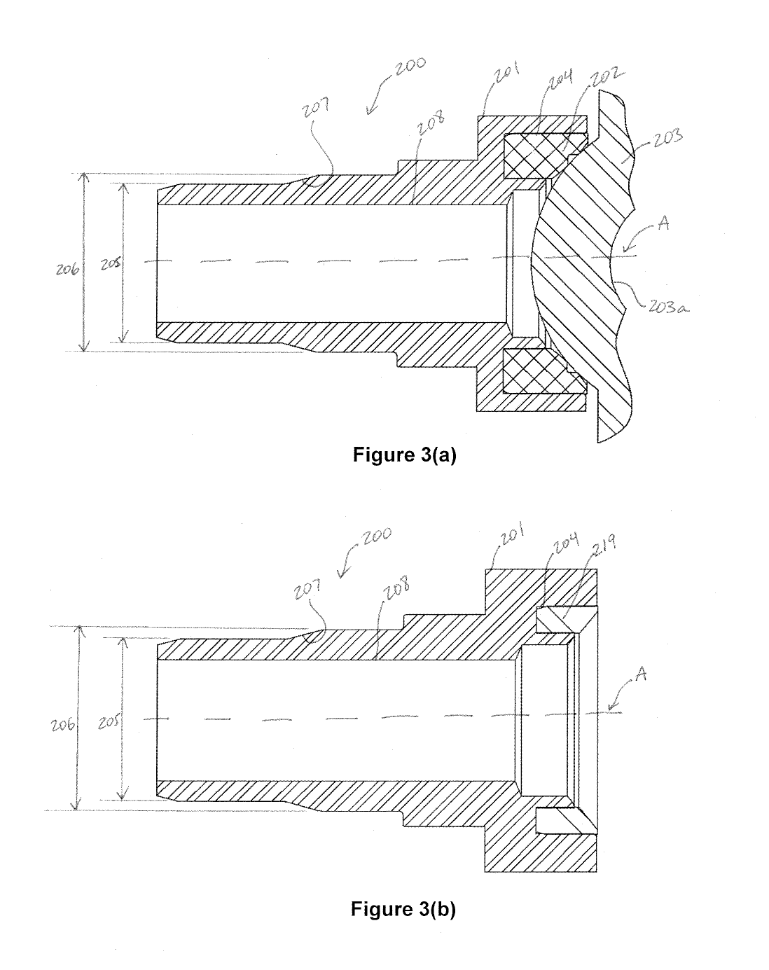

Turning now to FIGS. 3(a) and (b), exemplary seat retainers 201 for a ball valve are illustrated. Although depicting only a left side of the exemplary ball valve 200, it should be understood that a minor image of substantially similar components would be utilized on the right side of the ball valve, as illustrated in FIG. 2. In particular, FIG. 3(a) illustrates an exemplary seat retainer 201, seat 202 and ball 203. The exemplary ramped seat retainer 201 includes an annular cavity 204 for housing the seat 202. The seat 202 can be, e.g., pressed into the cavity 204. In addition, the face of the seat 202 is in substantial contact with the ball 203. The ramped seat retainer 201 further includes a seat retainer bore 208 extending therethrough which can connect to at least one bore 203a of the ball 203. The exemplary seat 202 and ball 203 configurations will be discussed in greater detail below.

Still with reference to FIGS. 3(a) and (b), the exemplary seat retainer 201 includes an outer surface with a first outer diameter 205, a second outer diameter 206 and a ramped transition region 207. The first and second outer diameters 205 and 206, respectively, are dimensionally unequal. Thus, rather than a “stepped” and/or continuous outer surface as taught by the prior art, the transition region 207 connects the first outer diameter 205 and the second outer diameter 206 in a ramped manner, e.g., sloped, angled, inclined, or the like. Although illustrated as a specific angle, e.g., slope, it should be understood that the first and second outer diameters 205 and 206 can vary in dimension, thereby creating different slopes of the transition region 207. For example, as depicted, the first outer diameter 205 can be dimensionally smaller than the second outer diameter 206, thus creating an acute angle of the transition region 207. The ramped transition region 207 permits the use of two differently sized spring-loaded resilient seals, which generate a sealing force between the face of the seat 202 and the ball 203 under normal operation. The ramped transition region 207 further permits a transfer of pressure forces generated under normal operating conditions into the ramped seat retainer 201 and/or the ramped end adapter, rather than into both of the spring-loaded resilient seals. Although illustrated with an exemplary seat 202, it should be understood that the exemplary seat retainer 201 can be implemented in conjunction with a conventional seat 219 as illustrated in FIG. 3(b).

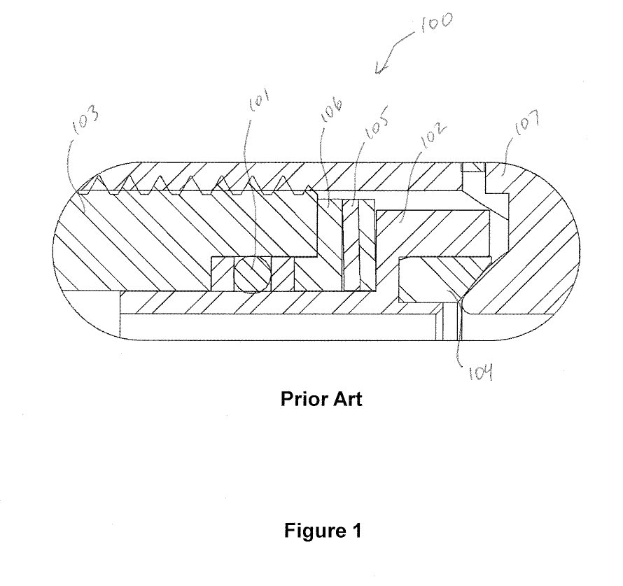

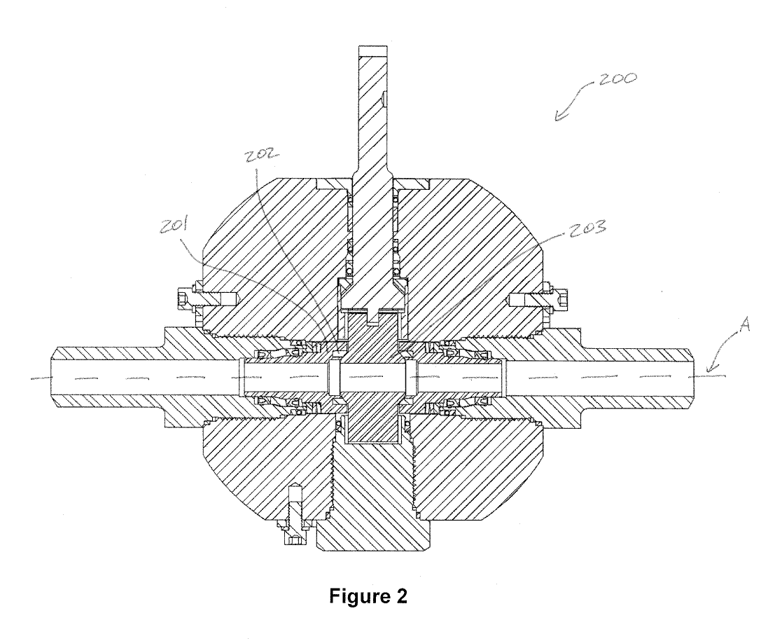

As discussed previously with respect to the prior art ball valve 100 of FIG. 1, an elastomeric O-ring 101 effects a seal between the outside diameter of the seat retainer 102 and the inside diameter of the end adapter 103. The elastomeric O-ring 101 can also accept pressure in more than direction. However, the elastomeric O-ring 101 has limited operating parameters, e.g., pressures, temperatures, process fluids, and the like.

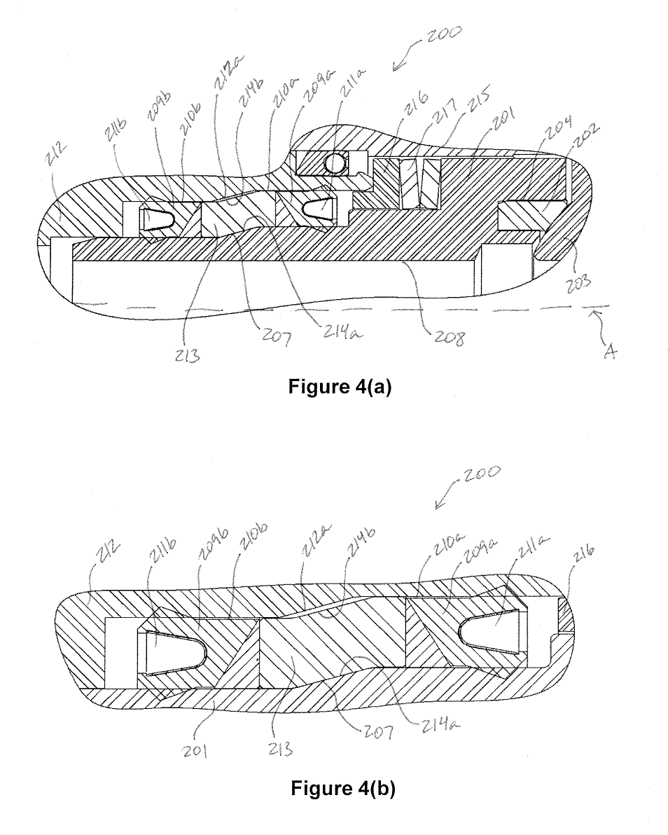

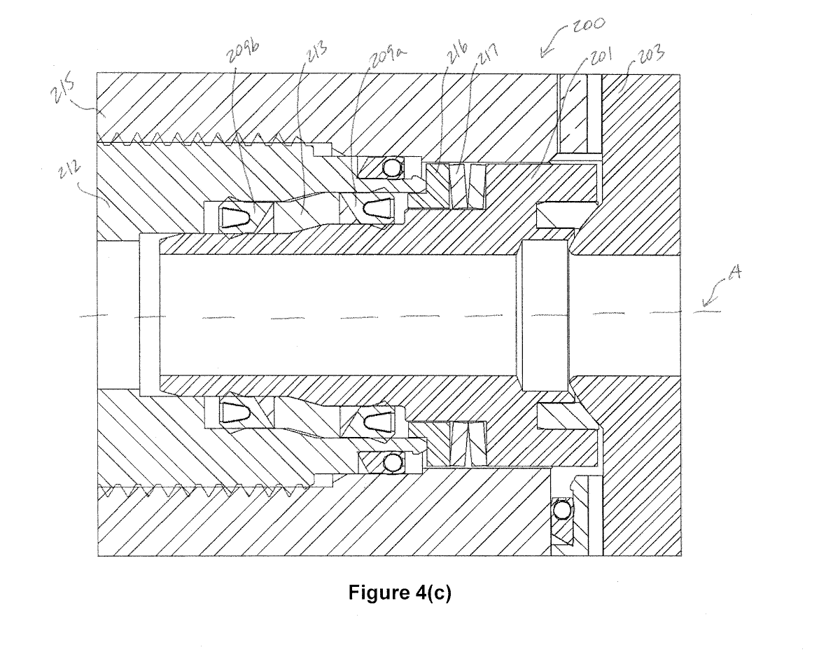

In exemplary embodiments, the ball valve 200 of FIG. 4(a) includes first and second non-elastomeric seals 209a and 209b, respectively, for managing the pressure differential in the ball valve 200. Although illustrated with two non-elastomeric seals, in other embodiments, more than two non-elastomeric seals, e.g., three, four, or the like, can be used. The first and second non-elastomeric seals 209a and 209b can be, e.g., spring-loaded resilient seals made from engineered plastic materials, e.g., Teflon™-based engineered plastic materials, and the like. In particular, the exemplary first and second non-elastomeric seals 209a and 209b can have a substantially cylindrical configuration and can include first and second metal springs 211a and 211b, e.g., wound springs, live-loading apparatus, or the like, and first and second Teflon™ shells 210a and 210b. The first and second non-elastomeric seals 209a and 209b can pressure in one direction, while the first and second metal springs 211a and 211b create a pressure differential inside the valve body 215 to create a sealing force. Specifically, as a process pressure force is applied to the valve body 215, the pressure force is relied upon to generate a load from the seat retainer 201 to the seat 202 against the ball 203 to create a durable and/or tight seal at high pressures. Advantages of implementing the first and second non-elastomeric seals 209a and 209b rather than the elastomeric O-ring 101 are, e.g., the compatibility of the non-elastomeric material of fabrication with a variety of process fluids, the range of temperatures suitable for operation, and the like. Exemplary process fluids, e.g., mineral and/or water-based hydraulic fluids, alcohols such as methanol, scale and/or corrosion inhibitors, and the like. Exemplary temperatures suitable for operation range from, e.g., about −20° F. to about 250° F.

Still with reference to FIG. 4(a), unlike the elastomeric O-ring 101 of FIG. 1 which provides a sealing pressure in both directions, the first and second metal springs 211a and 211b provide a sealing force in only one direction. For example, the first metal spring 211a can provide a force in the right direction and the second metal spring 211b can provide a force in the left direction along an axis parallel to the “A” axis. Further, due to the configuration of the first and second non-elastomeric seals 209a and 209b, a pressure force can only be applied to and/or accepted by the first and second metal springs 211a and 211b, not the first and second Teflon™ shells 210a and 210b. For example, a pressure force can be applied in the left direction on the first metal spring 211a and a pressure force can be applied in the right direction on the second metal spring 211b along an axis parallel to the “A” axis. Thus, due to the nature of the spring-loaded first and second non-elastomeric seals 209a and 209b, the resilient seals are unable to seal against pressure in both directions. This limitation can be overcome by positioning the first and second non-elastomeric seals 209a and 209b back-to-back to protect each seal from pressure forces in both directions, i.e., pressure forces directed at the first and second Teflon™ shells 210a and 210b. However, the first and second metal springs 211a and 211b of the first and second non-elastomeric seals 209a and 209b can be insufficiently durable on their own to withstand and/or hold system pressures of between about 10,000 psi to about 20,000 psi. Further, the first and second non-elastomeric seals 209a and 209b must transfer a force to the seat 202 and, thereby, create a seal between the seat 202 and the ball 203.

The ability to withstand high pressure forces and to transfer pressure forces to the seat 202 can be achieved by implementation of the ramped seat retainer 201 discussed above, in conjunction with an end adapter 212 and a load ring 213. Although illustrated with one load ring 213, in other embodiments, more than one load ring 213, e.g., two, three, or the like, can be used. In particular, the load ring 213 is disposed substantially between the first and second non-elastomeric seals 209a and 209b. The load ring 213 can be fabricated from, e.g., 316 stainless steel, duplex stainless steel, 17-4PH stainless steel, nickel-based corrosion resistant alloys, and the like, and can have a substantially cylindrical configuration. The inner load ring surface 214a and the outer load ring surface 214b of the load ring 213 can include a ramped, e.g., sloped, surface complimentary to the transition region 207 of the seat retainer 201. As would be understood by those of skill in the art, the load ring 213 has differing inner and outer diameters at opposing ends and ramped inner load ring surface 214a and outer load ring surface 214b connecting the differing diameters. Similarly, the end adapter 212 can have a sloping inner end adapter surface 212a complimentary to the transition region 207 of the seat retainer 201. The ramped seat retainer 201, ramped end adapter 212 and ramped load ring 213 can be implemented to appropriately mate with each other along the ramped, e.g., sloped, surfaces.

Accordingly, two differently dimensioned spring-loaded resilient seals, i.e., first and second non-elastomeric seals 209a and 209b, can be placed back-to-back on the first outer diameter 205 and second outer diameter 206 of the ramped seat retainer 201 and can further be separated by the load ring 213. The differing dimensions of the first and second non-elastomeric seals 209a and 209b can be appropriately configured to securely fit over the first outer diameter 205 and the second outer diameter 206. In addition, the differing dimensions of the first and second non-elastomeric seals 209a and 209b generate the sealing force necessary to create a sufficient seal of the seat 202 against the ball 203 under normal operating conditions. Exemplary normal operating conditions include, e.g., pressures in the range of about 10,000 psi to about 15,000 psi, temperatures in the range of about 60° F. to about 80° F., and the like. Exemplary normal operating conditions can further include, e.g., pressures in the range of about 10,000 psi to about 20,000 psi, temperatures in the range of about −20° F. to about 250° F., and the like. In particular, the exemplary configuration protects the first and second non-elastomeric seals 209a and 209b from pressurization in the reverse direction, while simultaneously allowing said seals to transmit the pressure force, e.g., load, required to generate a positive seal between the ball 203 and the seat 202.

For example, with reference to FIG. 4(a), a pressure force applied in the right direction along an axis parallel to the “A” axis against the second metal spring 211b of the second non-elastomeric seal 209b transfers the pressure force against the load ring 213, not the first non-elastomeric seal 209a. In turn, the load ring 213 transfers the pressure force against the seat retainer 201 along the mating surface area located at the transition region 207 of the seat retainer 201 and the inner load ring surface 214a of the load ring 213. The mating surface area at the transition region 207 prevents the pressure force from being applied to the side of the first non-elastomeric seal 209a not configured to receive a pressure force above a certain range. The pressure on the transition region 207 of the seat retainer 201 further forces the embedded seat 202 against the ball 203, thereby creating a durable and/or tight seal between the seat 202 and the ball 203. It should be understood that the transition region 207 and, thus, the mating surface area between the transition region 207 and the load ring 213, can vary in dimension. For example, the mating surface area, i.e., the contact area, can be increased and/or decreased. However, the mating surface area must be sufficiently large to transmit the necessary pressure force against the seat retainer 201 to create a satisfactory seal between the seat 202 and the ball 203. The sloped, i.e., ramped surface, of the seat retainer 201 transition region 207 functions in a substantially safer manner than the prior art teaching of applying a high pressure force against a step in the seat retainer 201, as the step may not provide a sufficient surface area to prevent dislodging of valve components positioned against the step. In particular, the exemplary ramped seat retainer 201 transition region 207 creates a larger contact surface area upon which a force can be applied and further transmitted to the seat 202 seal.

Similarly, a pressure force applied in the left direction along an axis parallel to the “A” axis against the first non-elastomeric seal 209a is transferred into the end adapter 212 at the mating surface area located at the ramped upper load ring surface 214b of the load ring 213 and the ramped inner end adapter surface 212a of the end adapter 212. The exemplary configuration prevents the pressure force from being applied to the side of the opposing second non-elastomeric seal 209b not configured to receive a force. The end adapter 212 can in turn transfer the pressure force against the valve body 215, which absorbs the pressure force and prevents it from transferring to further components of the exemplary ball valve 200.

The exemplary configuration of FIG. 4(a) can be modified by implementing a seat retainer 201 with equal first and second outer diameters 205 and 206, i.e., a uniform outer diameter of the seat retainer 201 tail. Thus, the first and second non-elastomeric seal 209a and 209b diameters would also be of equal dimensions. With the first and second non-elastomeric seals 209a and 209b positioned back-to-back with or without the load ring 213 therebetween, the first and second non-elastomeric seals 209a and 209b are free to translate along the seat retainer 201 outer surface based on an application of a pressure force in either direction. However, the side subject to damage due to pressure above a certain range of the first and second Teflon™ shells 210a and 210b can be damaged due to the opposing force application thereon. Thus, the implementation of the ramped seat retainer 201 in conjunction with the differently dimensioned first and second non-elastomeric seals 209a and 209b, the ramped end adapter 212 and the ramped load ring 213 offset the pressure forces, i.e., loads, to the seat retainer 201 and not to the side subject to damage of the first and second Teflon™ shells 210a and 210b of the first and second non-elastomeric seals 209a and 209b. In particular, the ramped load ring 213 transmits the pressure force directly to the ramped seat retainer 201 along the transition region 207, which in turn transmits the pressure force to the seat 202 seal against the ball 203. It should be noted that the exemplary ball valve 200 depicted in FIG. 4(a) also includes a follower 216 and springs 215, which will be discussed in greater detail below.

With reference to FIG. 4(b), a detailed view of exemplary ball valve 200 is provided. In particular, the first and second non-elastomeric seals 209a and 209b are positioned around the seat retainer 201 with the load ring 213 located therebetween. The first and second non-elastomeric seals 209a and 209b are configured to create, e.g., an interference fit between the first and second non-elastomeric seals 209a and 209b and the space between the seat retainer 201 and the end adapter 212, compressing the first and second non-elastomeric seals 209a and 209b therebetween. The ramped transition region 207 is configured to mate with the complimentary ramped inner load ring surface 214a when a pressure force is applied in the right direction along an axis parallel to the “A” axis against the second non-elastomeric seal 209b. Similarly, the outer load ring surface 214b and the inner end adapter surface 212a are configured to mate when a pressure force is applied in the left direction along an axis parallel to the “A” axis against the first non-elastomeric seal 209a.

FIG. 4(c) illustrates a left side of the exemplary ball valve 200, including the ramped seat retainer 201 and the ramped one piece load ring 213. Although depicting only a left side of the exemplary ball valve 200, it should be understood that a minor image of substantially similar components would be utilized on the right side of the ball valve, as discussed with respect to FIG. 2.

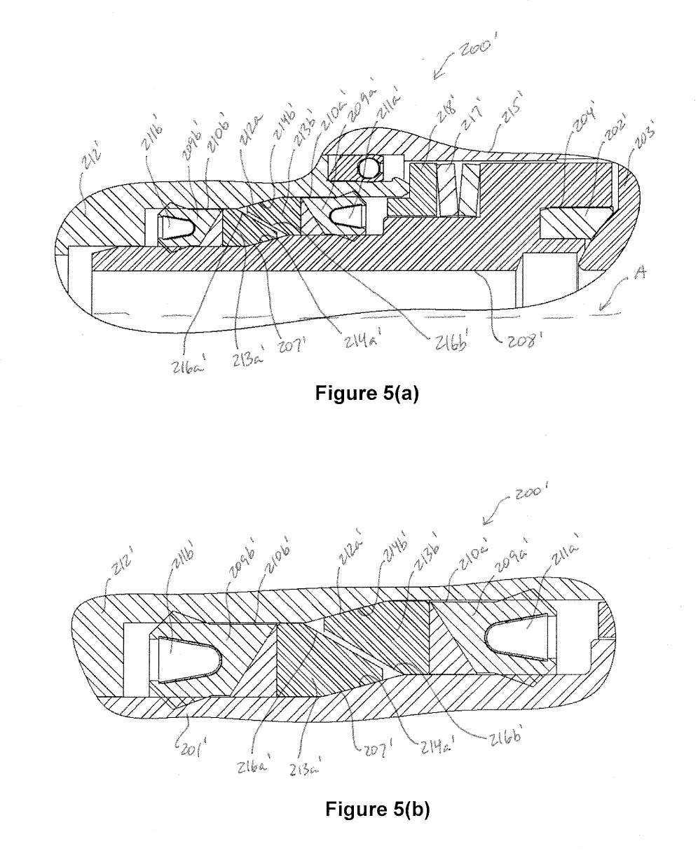

Turning now to FIGS. 5(a) and (b), another exemplary embodiment of the ball valve 200′ is provided. In particular, the ball valve 200′ is similar in structure and function to the ball valve 200 of FIGS. 4(a)-(c), except for rather than including a single-piece load ring 213, the exemplary ball valve 200′ includes a multiple-piece load ring, i.e., independent first and second load rings 213a′ and 213b′, respectively. Thus, when a pressure force is applied in the right direction along an axis parallel to the “A” axis against the second non-elastomeric seal 209b′, the force is transmitted and/or transferred into the first load ring 213a′. The inner load ring surface 214a′ defines a ramped surface configured to mate with the transition region 207′ of the seat retainer 201′, i.e., the inner load ring surface 214a′ applies a pressure against the transition region 207′. The force is thereby transferred from the first load ring 213a′ into the seat retainer 201′ through the mating surface area, which in turn transfers the force through the seat 202′ against the ball 203′ to create a durable and/or tight seal therebetween. The first and second load ring surfaces 216a′ and 216b′ can be configured in an opposing, spaced relation. Thus, when a force is applied to the first load ring 213a′ in the right direction along an axis parallel to the “A” axis, the force is transferred into the seat retainer 201′. However, the first and second load rings 213a′ and 213b′ are prevented from pressing against each other along the first and second load ring surfaces 216a′ and 216b′. This exemplary configuration prevents damage to the side subject to damage of the first and second Teflon™ shells 210a′ and 210b′ of the first and second non-elastomeric seals 209a′ and 209b′.

Similarly, when a pressure force is applied in the left direction along an axis parallel to the “A” axis against the first non-elastomeric seal 209a′, the force is transferred to the second load ring 213b′. The second load ring 213b′ further transfers the force into the end adapter 212′ along the mating surface, i.e., the ramped inner end adapter surface 212a′ and the outer load ring surface 214b′. The end adapter 212′ can transfer the pressure force into the valve body 215′, which absorbs the forces generated and prevents the force from being transferred to alternative ball valve 200′ components.

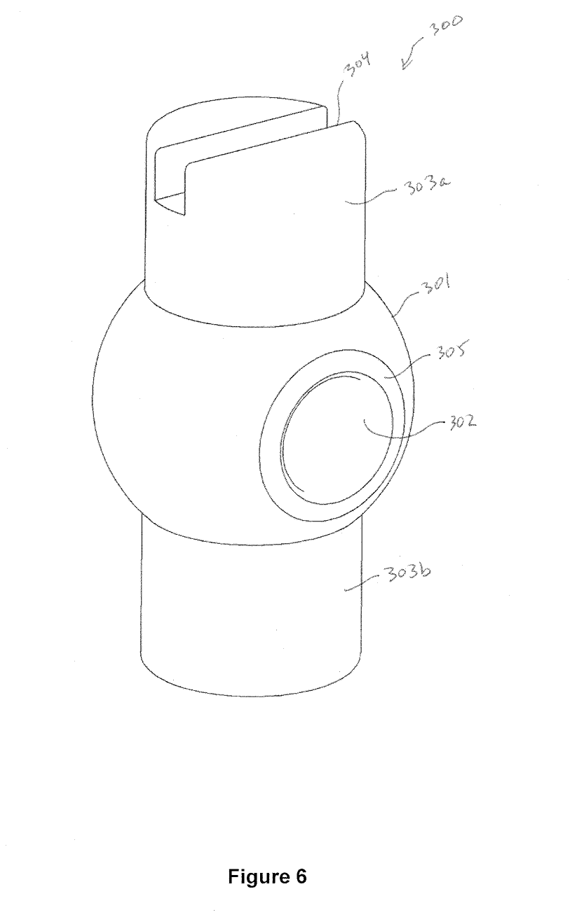

With reference now to FIG. 6, an exemplary embodiment of a ball 300 to be implemented with the exemplary ball valves of the present disclosure is provided. In particular, the ball 300 can include a ball spherical surface 301 and a ball bore 302, e.g., a port, extending therethrough. The ball 300 can include a first trunnion 303a and a second trunnion 303b for supporting and/or anchoring the ball 300 in the valve body 215. The first and second trunnions 303a and 303b assist in stabilizing the ball 300 in high pressure conditions. The first trunnion 303a can further include a slot 304 for accepting and mating with a valve stem to permit mechanical communication between the ball 300 and the valve stem. Specifically, the slot 304 permits the ball 300 to be “keyed” to a valve stem, thereby allowing the ball 300 to be actuated, e.g., axially turned, by rotating a valve stem in a particular direction.

As stated previously with respect to FIG. 1, the intersection of the ball spherical surface 301 and the ball bore 302 creates a sharp edge which produces large pressure drops across the small flow passage when the ball 300 is rotated relative to the seat 202. Specifically, as the ball 300 is axially rotated to open and/or close the valve, the small flow area between the seat 202 and the ball 300 through which fluid passes generates high pressures and/or fluid velocities. Thus, the exemplary ball 300 includes a chamfered edge 305, e.g., a beveled edge, at the intersection of the ball spherical surface 301 and the ball bore 302. The chamfered edge 305 can further be broken with, e.g., a radius. The chamfered edge 305 exposes a larger flow area than a non-chamfered ball bore 302. In particular, as the ball 300 axially rotates to open and/or close the valve, a larger flow area for fluid to pass through is created by the chamfered edge 305, which in turn permits lower velocities and/or pressures at the passage. Thus, the negative effects, e.g., seat 202 damage, of large pressure drops across a small flow area of the exposed resilient seat 202 surface can be mitigated. It should further be understood that the angle of the chamfered edge 305 is merely exemplary and that alternative angles can be implemented based on, e.g., the operating pressures and flows desired.

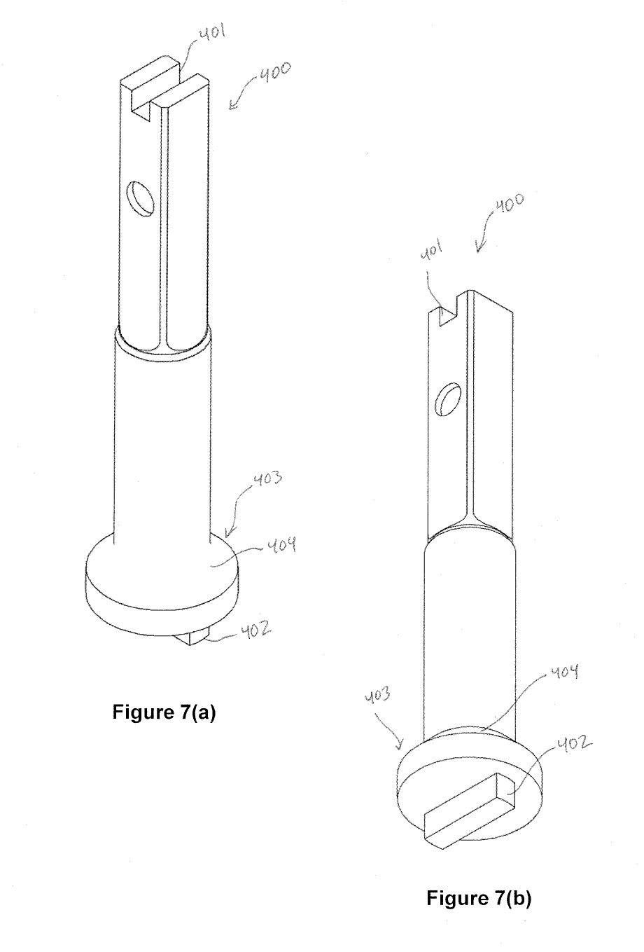

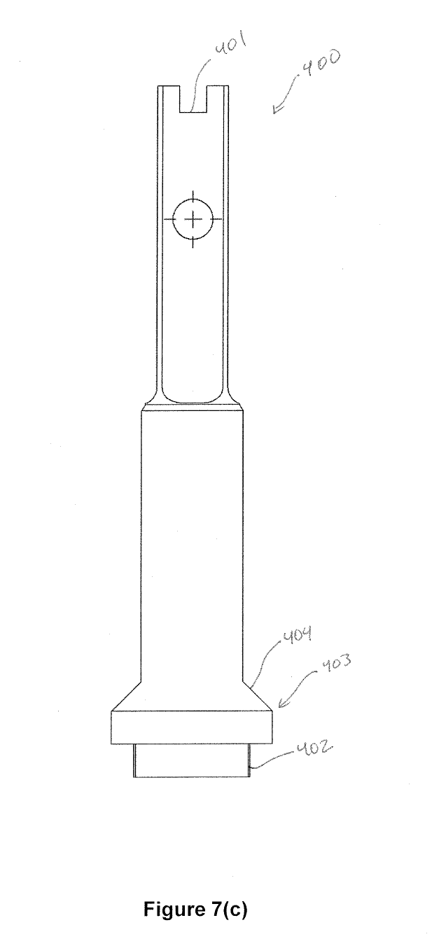

Turning now to FIGS. 7(a)-(c), exemplary embodiments of a stem 400 are provided. In exemplary embodiments, the stem is maintained outside of the pressurized cavity of the valve body. The sealing mechanism can be removed from the stem and placed on each end of the first and second trunnions 303a and 303b of the ball 300. Thus, the first and second trunnions 303a and 303b act as pressure sealed first and second trunnion 303a and 303b supports. The stem 400 includes a stem slot 401 configured and dimensioned to mate with an actuator, e.g., a handle, outside of the valve body. The stem 400 and the actuator can therefore be in mechanical communication relative to each other. For example, the actuator can be rotated to axially turn the stem 400 in the ball valve 200.

The stem 400 includes a stem head 403 with a tapered stem surface 404. The stem head 403 also includes a stem head protrusion 402 configured and dimensioned to mate with the slot 304 of the trunnion 303a of the ball 300. Thus, the stem 400 and the ball 300 can be in mechanical communication relative to each other. For example, the slot 304 permits the ball 300 to be “keyed” to the stem head protrusion 402 to be actuated, e.g., axially turned, by rotating the valve stem 400 in a particular direction. In this exemplary configuration, the majority of frictional forces associated with the valve stem and bearing arrangement in a conventional ball valve 100 are removed. Thus, the remaining minimal frictional forces are only associated with the sealing mechanism. FIG. 7(c) illustrates a side view of the exemplary stem 400, including the stem slot 401 and the stem protrusion 402.

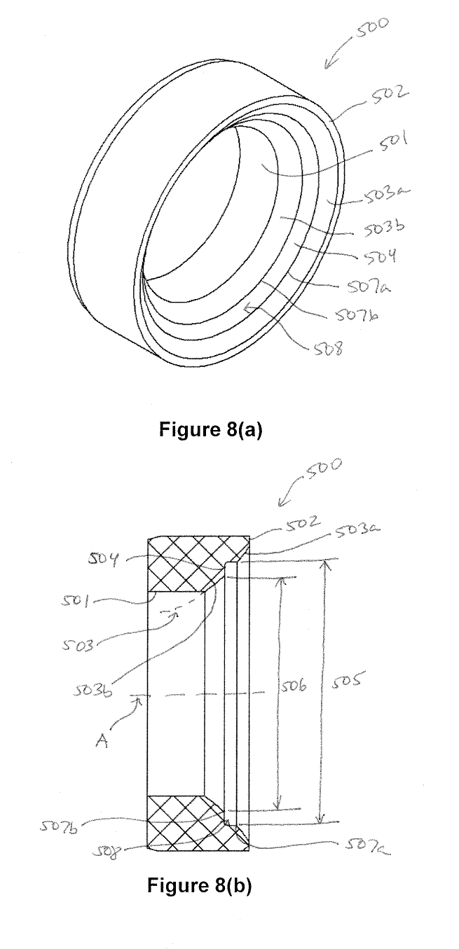

With reference to FIGS. 8(a) and (b), an exemplary embodiment of a seat 500 is provided. The exemplary seat 500 has a cylindrically shaped ring configuration with a seat bore 501 extending therethrough. A first seat end 502 can include a torus-shaped convex face cut 503 (hereinafter “convex face cut 503”). An annular groove 504, e.g., a relief groove, can be further cut into the convex face cut 503. The annular groove 504 in the convex face cut 503 forms an outer convex seat face 503a and an inner convex seat face 503b with an empty void 508 in between. Further, the annular groove 504 can be oriented such that the annular groove outer diameter 505 is larger than the seat retainer 201 tail diameter, i.e., the outside diameter of the “tail” portion of the seat retainer 201, and the annular groove inner diameter 506 can be smaller than the seat retainer 201 tail diameter. The exemplary seat 500 can be fabricated from, e.g., a thermoplastic ring with a convex face cut 503 and an annular groove 504, e.g., a relief groove, machined along the convex face cut 503. It should be understood that definite tolerances and/or precision of the machined annular groove 504 should be implemented to reduce the internal pressures involved. The thermoplastic material of fabrication of the seat 500 can be, for example, PEEK, a PEEK filled with glass and/or carbon, a Torlon™ compound, a Vespel™ compound, and the like.

Thus, rather than having a single point of contact as currently implemented in conventional ball valves 100 depicted in FIG. 1, the exemplary configuration results in the formation of two distinct seating surfaces, i.e., a first seating surface face 507a and a second seating surface face 507b, separated by an empty void 508. In particular, the convex face cut 503 and annular groove 504 ensure two distinct contact points and/or edges, i.e., first and second seating surface faces 507a and 507b, between the ball 300 and the seat 500. The annular groove 504 can be further configured to permit simultaneous contact of the annular groove outer diameter 505, i.e., the first seating surface face 507a, and the annular groove inner diameter 506, i.e., the second seating surface face 507b, with the spherical surface 301 of the ball 300. The two distinct points of contact ensure accurate prediction of a seat area, i.e., surfaces of the seat 500 in contact with the ball 300, formed during hydrostatic pressure. By accurately controlling the seat area, the piston load and/or seat 500 stresses are controlled during normal operation. In addition, the width of the annular groove 504 can be varied to control the plurality of forces acting on the seat 500 face, i.e., the outer convex seat face 503a and the inner convex seat face 503b, during valve operation. For example, by increasing the annular groove 504, the seat 500 area and/or piston loads can be increased. Conversely, by reducing the annular groove 504, the seat 500 area and/or piston loads can be decreased. The annular groove 504 can further reduce the forces involved in utilized the seat 500 seal against the ball 300, thereby increasing the seat 500 life.

The convex face cut 503 of the seat 500 can provide a rapid divergence of the seat 500 face from the ball 300 face immediate the seat 500. The dual seat 500 face, i.e., the outer convex seat face 503a and the inner convex seat face 503b, on the upstream end of the valve allow the ball bore 302, i.e., port, to clear the inner convex seat face 503b and flow to pass over the inner convex seat face 503b, into the void 508 separating the outer convex seat face 503a and the inner convex seat face 503b, and further into the body cavity. Thus, the resilient seat 500 configuration eliminates a high pressure drop from occurring over the entire seating surface, i.e., first and second seating surface faces 507a and 507b.

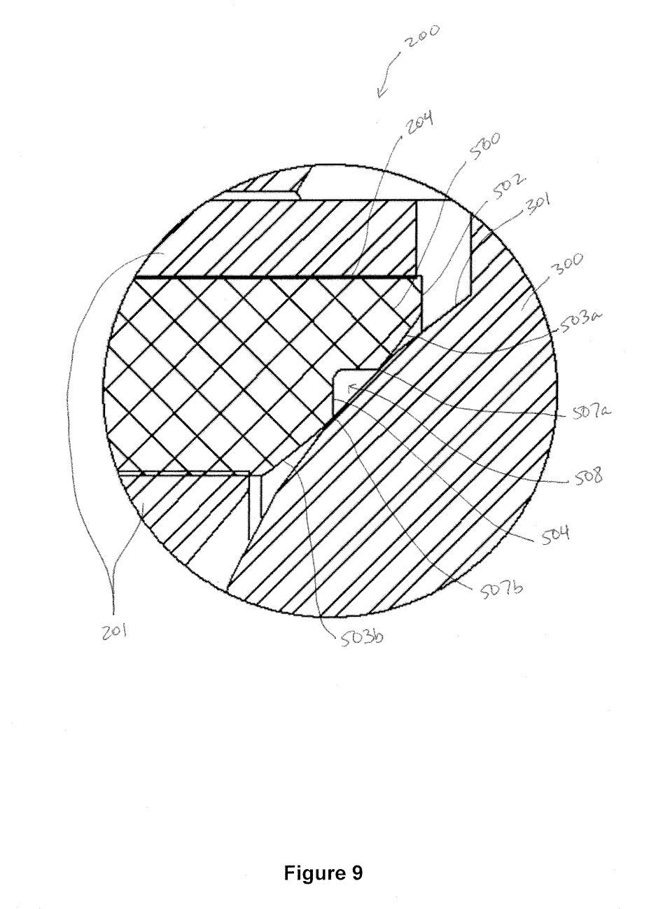

With reference to FIG. 9, the exemplary seat 500 is illustrated during implementation with the seat retainer 201 of the ball valve 200 discussed previously. In particular, a detailed view is provided of the two distinct contact points between the seat 500 and the spherical surface 301 of the ball 300. As can be seen from FIG. 9, the first and second seating surface faces 507a and 507b created by the annular groove 504 and the void 508 simultaneously contact the spherical surface 301 of the ball 300. These two distinct contact points provide a predictable seat 500 area. In addition, the convex seat cut 503, i.e., the outer convex seat face 503a and inner convex seat face 503b, provides a rapid divergence from the spherical surface 301 of the ball 300.

Still with reference to FIGS. 8(a), 8(b) and 9, in operation, when pressure is applied to the exemplary ball valves in, e.g., the right direction along an axis parallel to the “A” axis, the seat 500 can create a sufficiently durable and/or tight seal to prevent leakage of a fluid and/or pressure from passing into the ball bore 302. As mentioned previously, although the Figures illustrate only a left side, e.g., an upstream portion, of the exemplary ball valves, it should be understood that substantially similar components also exist on the right side, e.g., a downstream portion, of the ball 300. Thus, if the seat 500 fails to prevent leakage on the left side of the ball 300 and pressure passes to the ball bore 302, i.e., the internal cavity of the valve, a substantially similar seat 500 located on the downstream side of the ball 300 can act as a seal to prevent leakage further downstream.

As would be understood by those of skill in the art, ball valves undergo large pressure forces when operating in ranges between about 10,000 psi and 20,000 psi. The two distinct contact points, i.e., the first and second seating surface faces 507a and 507b, of the exemplary seat 500 create two separate sealing bands which provide a greater opportunity to balance loading forces inside the valve body. In particular, greater flexibility is permitted in transferring pressure loads from, e.g., the left seat 500 to the right seat 500, and vice versa. The force distribution inside the ball valve is thus enhanced due to the greater number of contact points between the seat 500 and the ball 300.

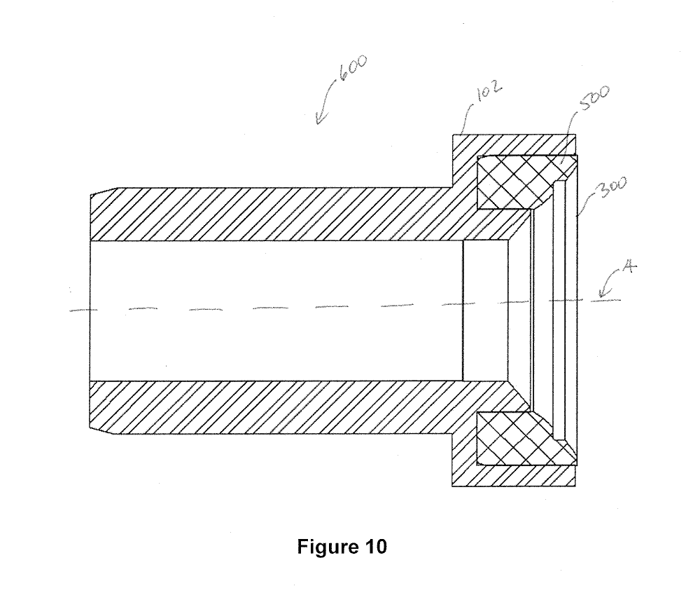

Turning now to FIGS. 3(a) and 10, the exemplary ball valve 200 is depicted including an exemplary ramped seat retainer 201 and an exemplary seat retainer assembly 600 is depicted with the seat 500 and a seat retainer 102 having a uniformly shaped outer diameter. With respect to the ball valve 200 of FIG. 3(a), the seat 202 can be configured as the seat 500 and the ball 203 can be configured as the ball 300. It should be understood that the configurations and/or dimensions of the seat 500, e.g., the radius of the convex face cut 503, the annular groove 504, the outer and inner convex seat faces 503a and 503b, and the like, can be adjusted accordingly based on, e.g., the type of seat retainer 201 implemented, the configuration of the ball 300, the operational flow pressures and/or velocities desired, and the like.

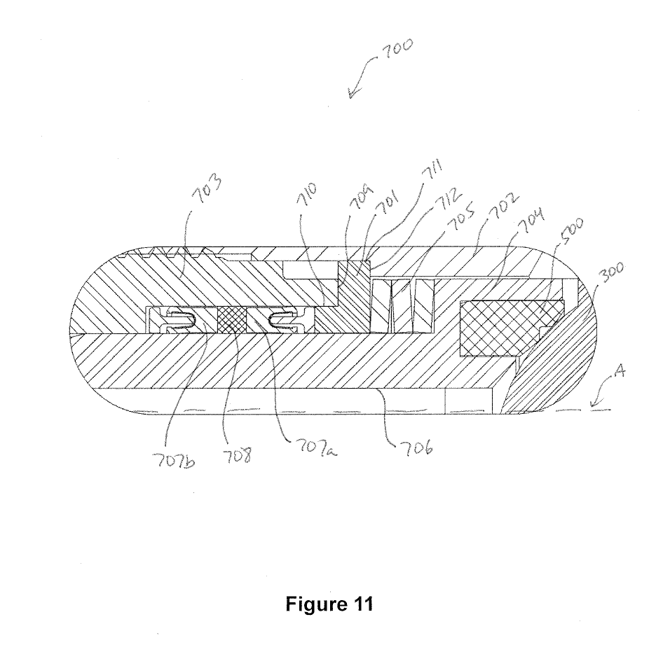

FIG. 11 illustrates an exemplary ball valve 700 including a supported follower 701. In particular, the exemplary ball valve 700 of FIG. 11 is substantially similar to the ball valve 200 described in FIGS. 4(a)-(c). Thus, the ball valve 700 includes a valve body 702, an end adapter 703, a load ring 708, a seat retainer 704, and first and second non-elastomeric seals 707a and 707b. It should be understood that in other embodiments, more than one load ring 708 can be used, e.g., two, three, or the like. Although illustrated with a uniformly dimensioned outer diameter, it should be understood that the ball valve 700 can implement a ramped seat retainer 201. Similarly, it should be understood that in conjunction with a ramped seat retainer 201, a ramped end adapter 212, ramped first and second non-elastomeric seals 209a and 209b, and a ramped load ring 213 can be implemented. Alternatively, rather than implementing the ramped valve components discussed herein with the first and second non-elastomeric seals 707a and 707b, an elastomeric seal and/or O-ring 101 can be utilized. The exemplary ball valve 700 also includes a seat 500, a ball 300, springs 705 and a follower 701. The springs 705 exert a force against the follower 701 to provide pressure against the seat retainer 704 and the seat 500, thereby creating a spring-loaded resilient seat 500.

Rather than implementing a free-floating follower 106, i.e., supported only by the end adapter 103 and springs 105, as described in FIG. 1, the exemplary ball valve 700 includes a follower 701 supported by at least one of the valve body 702 and the end adapter 703. The follower 701 can be substantially configured as an L-bracket. Thus, support and/or fixation of the follower 701 can be achieved by positioning the follower 701 between the seat retainer 704, a valve body bottom surface 711, a valve body side surface 712, an end adapter side surface 709, and an end adapter bottom surface 710. In particular, the end adapter side surface 709 and the valve body side surface 712 can prevent substantial movement and/or translation of the follower 701 along a horizontal axis, thereby controlling and/or balancing the amount of force transferred into the seat 500 and ball 300 seal. A high inlet pressure acting on the upstream seat retainer 704 seal therefore cannot displace the follower 701 from the end adapter 703. In particular, increasing inlet pressure acting on the upstream seat retainer 704 generates a force that is either absorbed in the end adapter 703 and/or transferred into the valve body 702, thereby preventing the higher inlet pressure forces from being absorbed by the resilient seat 500 face pressed against the ball 300.

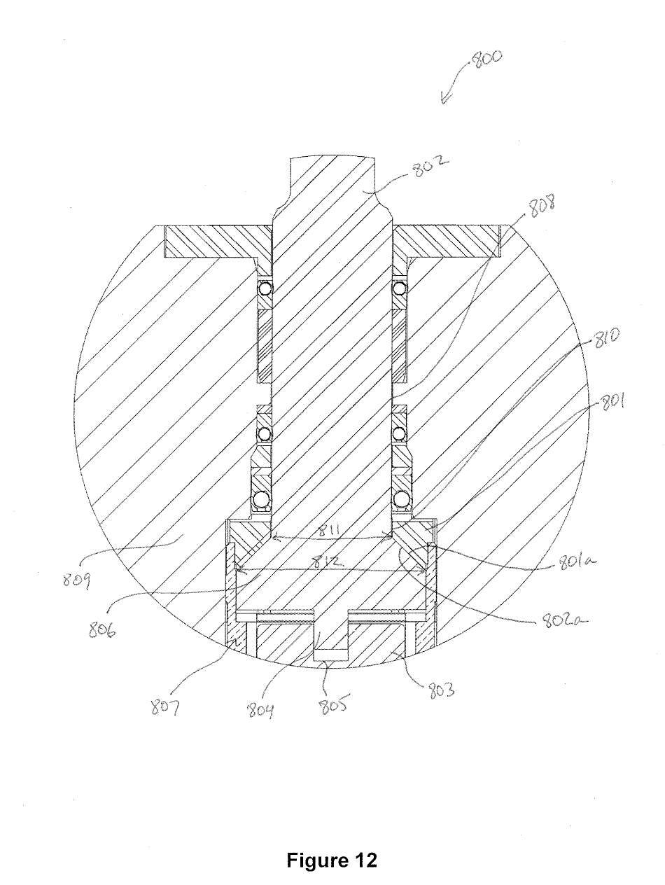

With reference to FIG. 12, an exemplary embodiment of a tapered stem bearing 801 of ball valve 800 according to the present disclosure is provided. Conventionally, when a stem head 806 is internally positioned in a pressurized body cavity 807 and pressure is applied to the pressurized body cavity 807, the stem head 806 can be pushed and/or forced upwards and out of the valve body opening 808. A flat bearing (not shown) can be positioned between the valve body opening 808 and the stem head 806 to prevent such ejection of the stem head 806 from the pressurized body cavity 807. However, such flat bearings can create high friction forces, resulting in high torque requirements for turning the stem 802.

The exemplary ball valve 800 of FIG. 12 includes a stem 802 which is configured to be in mechanical communication with the ball 300 (not shown). In particular, the stem 802 can include a stem head 806 and a stem head protrusion 804 for mating with a slot 805 of a trunnion 803 connected to the ball 300. An exemplary stem bearing 801 can be disposed between the stem head 806 and the valve body opening 808 of the valve body 809. The stem bearing 801 can further include a stem bearing bore 810 extending therethrough and a tapered stem bearing surface 801a along a transition region connecting a first stem bearing inner diameter 811 and a second stem bearing inner diameter 812. The first stem bearing inner diameter 811 and the second stem bearing inner diameter 812 are dimensionally unequal. Thus, an angled surface is created along the transition region, i.e., the tapered stem bearing surface 801a. The stem head 806 of the stem 802 can also include a tapered stem surface 802a configured to mate with the tapered stem bearing surface 801a. As would be understood by those of skill in the art, when a high pressure is applied to the pressurized body cavity 807, the upwardly directed force of the stem head 806 against the stem bearing 801 redirects and/or deflects a majority of the load perpendicular to a top stem bearing 801 surface and into the valve body 809. Thus, the exemplary configuration of the stem bearing 801 reduces the torque and/or the frictional forces involved in turning the stem 802 and/or to operate the ball valve 800. Although illustrated as being implemented in conjunction with a trunnion 803, it should be understood that the exemplary tapered stem bearing 801 can be implemented with both floating-style ball valves and/or ball valves that include trunnion supports.

Thus, the exemplary ball valves and associated methods according to the present disclosure provide ball valves capable of implementation in a wide range of applications, e.g., having varied fluid compatibility, temperature constraints, and the like. Further, the exemplary ball valves and associated methods provide ball valves that reduce seat stresses and operating torque, decrease pressure drops across the exposed seat surfaces and increase seat life. It should be understood that the exemplary embodiments described herein can be utilized separately and/or in combination with each other as desired.

While exemplary embodiments have been described herein, it is expressly noted that these embodiments should not be construed as limiting, but rather that additions and modifications to what is expressly described herein also are included within the scope of the invention. Moreover, it is to be understood that the features of the various embodiments described herein are not mutually exclusive and can exist in various combinations and permutations, even if such combinations or permutations are not made express herein, without departing from the spirit and scope of the invention.

1. A ball valve, comprising:
a valve body;
a ball disposed inside the valve body;
a seat retainer that includes an outer surface with a first outer diameter, a second outer diameter and a transition region disposed therebetween, the transition region extending in a ramped manner between the first outer diameter and the second outer diameter; and
a seat disposed inside the seat retainer and in contact with the ball.

2. The ball valve of claim 1, wherein the seat retainer comprises a seat retainer bore extending therethrough.

3. The ball valve of claim 1, wherein the first outer diameter and the second outer diameter are dimensionally unequal.

4. The ball valve of claim 1, wherein the valve body comprises an ingress port and an egress port.

5. The ball valve of claim 1, wherein the ball comprises a ball bore extending therethrough.

6. The ball valve of claim 1, comprising a first non-elastomeric seal and a second non-elastomeric seal.

7. The ball valve of claim 6, wherein the first and second non-elastomeric seals are spring-loaded.

8. The ball valve of claim 6, wherein the first and second non-elastomeric seals are dimensionally unequal.

9. The ball valve of claim 6, comprising a ramped load ring disposed between the first and second non-elastomeric seals.

10. The ball valve of claim 9, wherein the ramped load ring includes a ramped load ring surface complimentary to the transition region of the seat retainer.

11. The ball valve of claim 9, comprising a ramped end adapter in contact with the first and second non-elastomeric seals, the ramped load ring, and the seat retainer.

12. The ball valve of claim 11, wherein the ramped end adapter includes a ramped end adapter surface complimentary to the transition region of the seat retainer.

13. The ball valve of claim 11, wherein the ramped load ring transfers a pressure force to the seat retainer.

14. The ball valve of claim 11, wherein the ramped load ring transfers a pressure force to the ramped end adapter.

15. The ball valve of claim 13, wherein transferring the pressure force to the seat retainer presses the seat against the ball to create a seat seal.

16. The ball valve of claim 5, comprising a chamfered edge at an intersection of a spherical surface of the ball and the ball bore.

17. The ball valve of claim 16, wherein the chamfered edge is broken with a radius.

18. The ball valve of claim 1, comprising a valve stem positioned externally to a cavity of the valve body.

19. The ball valve of claim 1, wherein the ball comprises a trunnion.

20. A ball valve, comprising:
a valve body;
a ball disposed inside the valve body;
a seat retainer; and
a seat disposed inside the seat retainer and in contact with the ball, the seat including an annular groove on a seat face to provide two distinct contact points between the seat face and the ball.

21. The ball valve of claim 20, comprising a supported follower and an end adapter.

22. The ball valve of claim 21, wherein the supported follower is supported by at least one of the valve body and the end adapter.

23. The ball valve of claim 20, wherein the seat face comprises a torus-shaped convex face cut.

24. The ball valve of claim 23, wherein the annular groove is machined into the torus-shaped convex face cut.

25. The ball valve of claim 20, wherein the seat is a cylindrically shaped ring.

26. The ball valve of claim 20, wherein a first edge and a second edge of the annular groove contact the ball simultaneously.

27. The ball valve of claim 20, wherein the two distinct contact points between the seat face and the ball enhance a force distribution inside the valve body.

28. A ball valve, comprising:
a valve body;
a ball disposed inside the valve body;
a stem passing through a valve body opening and in mechanical communication with the ball; and
a stem bearing disposed between the stem and the valve body that includes a bore extending therethrough, a first inner diameter, a second inner diameter and a transition region, the transition region connecting the first inner diameter to the second inner diameter in a tapered manner.

29. The ball valve of claim 28, wherein the first inner diameter and the second inner diameter are dimensionally unequal.

30. The ball valve of claim 28, wherein the stem comprises a tapered stem surface configured to mate with the transition region of the stem bearing.

31. The ball valve of claim 28, wherein the stem bearing is one of a metallic or a thermoplastic bearing washer.

32. The ball valve of claim 28, wherein the stem bearing redirects a pressure force into the valve body.

33. A ball valve, comprising:
a valve body;
a ball disposed inside the valve body;
a seat retainer that includes an outer surface with a first outer diameter, a second outer diameter and a seat retainer transition region, the seat retainer transition region connecting the first outer diameter and the second outer diameter in a ramped manner;
a seat disposed inside the seat retainer and in contact with the ball, the seat including an annular groove on a seat face to provide two distinct contact points between the seat face and the ball;
a stem passing through a valve body opening and in mechanical communication with the ball; and
a stem bearing disposed between the stem and the valve body, the stem bearing including a bore extending therethrough, a first inner diameter, a second inner diameter and a stem bearing transition region, the stem bearing transition region connecting the first inner diameter and the second inner diameter in a tapered manner.

34. A method of fabricating a ball valve, comprising:
providing a valve body;
providing a ball disposed inside the valve body;
providing a seat retainer that includes an outer surface with a first outer diameter, a second outer diameter and a transition region, the transition region connecting the first outer diameter and the second outer diameter in a ramped manner; and
providing a seat disposed inside the seat retainer and in contact with the ball.

35. The method of claim 34, comprising providing a first non-elastomeric seal and a second non-elastomeric seal.

36. The method of claim 35, comprising providing a ramped load ring disposed between the first and second non-elastomeric seals.

37. The method of claim 36, comprising providing a ramped end adapter in contact with the first and second non-elastomeric seals, the ramped load ring, and the ramped seat retainer.

38. The method of claim 34, comprising providing a chamfered edge at an intersection of a spherical surface of the ball and a ball bore extending therethrough.

39. The method of claim 34, comprising providing a valve stem positioned externally to a cavity of the valve body.

40. A method of fabricating a ball valve, comprising:
providing a valve body;
providing a ball disposed inside the valve body;
providing a seat retainer; and
providing a seat disposed inside the seat retainer and in contact with the ball, the seat including an annular groove on a seat face to provide two distinct contact points between the seat face and the ball.

41. The method of claim 40, comprising providing a supported follower and an end adapter.

42. The method of claim 41, wherein the supported follower is supported by at least one of the valve body and an end adapter.

43. A method of fabricating a ball valve, comprising:
providing a valve body;
providing a ball disposed inside the valve body;
providing a stem passing through a valve body opening and in mechanical communication with the ball; and
providing a stem bearing disposed between the stem and the valve body, the stem bearing including a bore extending therethrough, a first inner diameter, a second inner diameter and a transition region, the transition region connecting the first inner diameter to the second inner diameter in a tapered manner.

44. A method of fabricating a ball valve, comprising:
providing a valve body;
providing a ball disposed inside the valve body;
providing a seat retainer that includes an outer surface with a first outer diameter, a second outer diameter and a seat retainer transition region, the seat retainer transition region connecting the first outer diameter and the second outer diameter in a ramped manner;
providing a seat disposed inside the seat retainer and in contact with the ball, the seat including an annular groove on a seat face to provide two distinct contact points between the seat face and the ball;
providing a stem passing through a valve body opening and in mechanical communication with the ball; and
providing a stem bearing disposed between the stem and the valve body, the stem bearing including a bore extending therethrough, a first inner diameter, a second inner diameter and a stem bearing transition region, the stem bearing transition region connecting the first inner diameter and the second inner diameter in a tapered manner.

45. A ball valve, comprising:
a valve body;
a ball disposed inside the valve body;
a seat retainer;
a seat disposed inside the seat retainer and in contact with the ball; and
a first seal and a second seal in an opposed relation disposed circumferentially about an outer surface of the seat retainer.

46. The ball valve of claim 45, wherein the first and the second seals are non-elastomeric seals.

47. The ball valve of claim 46, wherein the first and second seals are spring-loaded.

48. The ball valve of claim 45, comprising a load ring disposed between the first and second seals.

49. The ball valve of claim 45, wherein the first and second seals manage a pressure differential in the ball valve.

50. The ball valve of claim 45, wherein the first seal extends circumferentially about a first diameter of the seat retainer and the second seal extends circumferentially about a second diameter of the seat retainer.

51. The ball valve of claim 50, wherein the first diameter of the seat retainer and the second diameter of the seat retainer are different diameters.

52. The ball valve of claim 45, wherein the seat includes an annular groove on a seat face to provide two distinct contact points between the seat face and the ball.

53. The ball valve of claim 52, wherein the first and second seals in cooperation with the two distinct contact points between the seat face and the ball translate a pressure differential into a sealing force between the seat and the ball.

54. A method of fabricating a ball valve, comprising:
providing a valve body;
providing a ball disposed inside the valve body;
providing a seat retainer;
providing a seat disposed inside the seat retainer and in contact with the ball; and
providing a first seal and a second seal in an opposed relation disposed circumferentially about an outer surface of the seat retainer.

55. The method of claim 54, comprising providing a load ring disposed between the first and second seals.
